(19) United States
(12) Patent Application Publication
(10) Pub. No.: US 2017/0162306 A1
(43) Pub. Date: Jun. 8, 2017

(54) SOFT MAGNETIC STEEL AND METHOD FOR MANUFACTURING SAME, AND SOFT MAGNETIC COMPONENT OBTAINED FROM SOFT MAGNETIC STEEL

(71) Applicant: KABUSHIKI KAISHA KOBE SEIKO SHO (KOBE STEEL, LTD.), Kobe-shi (JP)

(72) Inventors: Kei MASUMOTO, Kobe-shi (JP); Masamichi CHIBA, Kobe-shi (JP)

(73) Assignee: KABUSHIKI KAISHA KOBE SEIKO SHO (KOBE STEEL, LTD.), Kobe-shi (JP)

(21) Appl. No.: 15/038,756

(22) PCT Filed: Nov. 20, 2014
(86) PCT No.: PCT/JP2014/080723

§ 371 Date: May 24, 2016

(30) Foreign Application Priority Data
Nov. 29, 2013 (JP) 2013-248384
May 13, 2014 (JP) 2014-099410

(51) Int. Cl. H01F 1/147; C22C 38/34; C22C 38/32; C22C 38/28; C22C 38/26; C21D 1/18; C22C 38/06; C22C 38/04; C22C 38/02; C22C 38/00; C21D 9/00; C21D 8/00; C22C 38/60; C22C 38/14

(52) U.S. Cl. CPC H01F 1/147; C22C 38/60; C22C 38/34; C22C 38/32; C22C 38/28; C22C 38/26; C22C 38/14; C22C 38/06; C22C 38/04; C22C 38/02; C22C 38/004; C22C 38/002; C22C 38/001; C21D 9/0068; C21D 8/005; C21D 1/18; C21D 2211/005; C21D 2211/004

(57) ABSTRACT

An object of the present invention to provide a soft magnetic steel that improves the magnetic properties, that is, the soft magnetic properties, the cold forgeability, and the magnetic aging characteristics without adding a large amount of alloy elements. The present invention is directed to a soft magnetic steel, including C, Mn, P, S, Al, and N in each predetermined amount, in which an area ratio of carbides and carbonitrides that have a thickness of less than 0.4 μm is 0.20 area % or less, and an area ratio M of carbides and carbonitrides that have a thickness of 0.4 μm or more in terms of percentage satisfies a relationship represented by the formula (1) below:

F=M−20×[C]>0 (1)

where [C] means a C content in the steel in percentage by mass.

### TECHNICAL FIELD

The present invention relates to a steel for a soft magnetic component with excellent magnetic aging characteristics and a method for manufacturing same, and a component formed using the steel. The form of the steel according to the present invention is not particularly limited and may be any one, such as a wire rod, a steel bar, or a sheet, but can be preferably applied to, especially the wire rod and steel bar.

### BACKGROUND ART

To meet the demands for energy saving of automobiles and the like, most of electric/electronic devices, such as electromagnetic components used in automobiles or the like, have been required to achieve power saving and accurate control. In particular, the steel used to configure magnetic circuits is further required to have magnetic properties, including easy magnetization under a weak external magnetic field and a small coercive force.

The above-mentioned steel normally applies a soft magnetic steel with a magnetic flux density therein that is highly responsive to external magnetic fields. Specifically, the soft magnetic steel suitable for use is, for example, an ultra-low carbon steel with a C content of about 0.1% or less by mass, in other words, a pure-iron based soft magnetic material and the like. Soft magnetic components used as the above-mentioned electromagnetic components are generally produced: by hot-rolling the steel; followed by secondary processing, specifically, pickling, a lubrication treatment, wire-drawing, and the like to obtain a steel wire; and subsequently making the resultant steel wire by way of forging, cutting, and magnetic annealing or the like. The steel material requires adequate formability for the component, including adequate forging properties and cutting performance. On the other hand, in some applications, components are formed by rolling the steel into a sheet and then pressing it.

For example, Patent Documents 1 and 2 propose techniques for the ultra-low carbon steel with excellent magnetic properties. These techniques focus on improving the strength and machinability of the steel without degrading its magnetic properties by controlling the steel composition and the dispersion state of carbides or sulfides in the steel.

In recent years, soft magnetic materials used to form magnetic circuits, such as actuators in driving systems, sensor systems, motors, and electromagnetic valves, have encountered with a serious problem of magnetic aging that as the magnetic circuit increases its operating frequency with enhanced performance, a temperature rise of the material due to self-heating will degrade the magnetic properties.

Such magnetic aging is further accelerated once distortion occurs due to processing, such as forging, cutting, or pressing, which might degrade the properties of electromagnetic components during use. For this reason, for example, Patent Documents 3 and 4 propose the techniques that improve the magnetic aging characteristics by adding a large amount of an alloy element. However, these techniques lead not only to an increase in cost of the alloy, but also to deterioration of productivity of the steel, such as manufacturability and component-workability.

Application of the magnetic annealing to the components is advantageous in suppressing the magnetic aging and improving the magnetic properties. However, in many cases, such magnetic annealing is omitted by giving higher priority to reduction in cost, depending on the properties required for the component.

Patent Document 1: JP 2009-084646 A

Patent Document 2: JP 2007-046125 A

Patent Document 3: JP 2012-233246 A

Patent Document 4: JP 2005-187846 A

### SUMMARY OF INVENTION

### Problems to be Solved by the Invention

The present invention has been made in view of the foregoing matter, and it is an object of the present invention to provide a soft magnetic steel that improves the magnetic properties, that is, the soft magnetic properties, the cold forgeability, and the magnetic aging characteristics without adding a large amount of alloy elements.

### Means for Solving the Problems

The present invention that has solved the foregoing problems provides a soft magnetic steel, including, in percent by mass:

C: 0.001 to 0.025%;

Mn: 0.1 to 1.0%;

P: exceeding 0% and 0.03% or less;

S: exceeding 0% and 0.1% or less;

Al: exceeding 0% and 0.010% or less; and

N: exceeding 0% and 0.01% or less,

with the balance being iron and inevitable impurities, wherein

an area ratio of carbides and carbonitrides that have a thickness of less than 0.4 μm is 0.20 area % or less, and

an area ratio M of carbides and carbonitrides that have a thickness of 0.4 μm or more in terms of percentage satisfies a relationship represented by the formula (1) below:

F=M−20×[C]>0 (1)

where [C] means a C content in the steel in percentage by mass.

The soft magnetic steel in the present invention has a composition of a ferrite single phase, and preferably has a ferrite crystal grain size number in a range of 2.0 to 7.0.

The soft magnetic steel in the present invention preferably includes at least one kind of element selected from the group consisting of, Si: 0.001 to 4.0%, Cr: 0.01 to 4.0%, B: 0.0003 to 0.01%, Ti: 0.001 to 0.05%, Nb: 0.001 to 0.02%, and Pb: 0.01 to 1.0%, as appropriate. These elements may be used independently or in combination. In particular, Nb is preferably used together with Ti. Note that in the present specification, all chemical compositions are represented in percent by mass.

The present invention also includes a method for manufacturing a soft magnetic steel, which includes the steps of:

heating a steel having any one of compositions mentioned above to 950 to 1,200° C.;

hot-rolling the steel at a finish rolling temperature of 850° C. or higher;

quenching the rolled steel to 700 to 500° C. at an average cooling rate of 4 to 10° C./sec for 10 to 100 seconds; and

subsequently performing a carbide precipitation process in a temperature range of 700 to 500° C. for 100 seconds or more, the carbide precipitation process including decreasing the average cooling rate to less than 1.0° C./sec or keeping the temperature of the steel constant.

Further, the present invention also includes a soft magnetic component obtained by cold-working any one of the soft magnetic steels mentioned above.

### Effects of the Invention

The soft magnetic steel in the present invention has adequate workability into a component because of its excellent cold forgeability and also adequate magnetic properties even when omitting the magnetic annealing, and can suppress the magnetic aging during use, thereby ensuring the stable magnetic properties in use. Therefore, the soft magnetic steel in the present invention is useful as materials for iron cores, such as an electromagnetic valve, a solenoid and a relay, magnetic shield materials, actuator members, and motor and sensor members, used in various electromagnetic components, including soft magnetic components for automobiles, trains, ships, etc.

### BRIEF DESCRIPTION OF THE DRAWINGS

FIG. 1 is a diagram schematically showing influences of the time and temperature of steel after hot-rolling on precipitation of carbides and the like.

### MODE FOR CARRYING OUT THE INVENTION

The inventors have intensively studied to solve the foregoing problems. Based on the results of the studies, it is found that to improve the magnetic properties and suppress the magnetic aging regarding the above-mentioned problems, it is very effective to precipitate carbides and carbonitrides (hereinafter referred to as “carbides and the like”) to reduce solid-solution C and solid-solution N, while controlling area ratios of carbides and the like depending on their sizes. Note that the term “carbonitrides” as used herein can include Fe₃(C, N) and the like that is obtained by substituting N for a part of C in a chemical composition ratio of Fe₃C.

A C content and an N content in the pure-iron based soft magnetic material are so small that carbides and the like are less likely to be formed, and are fine and used in a small amount. Due to the recent development of electron microscopes, the forms and precipitation amounts of fine carbides and the like contained in a small amount have been discovered. It has been found that the forms and precipitation amounts of carbides and the like are significantly influenced by manufacturing conditions even though the content of fine carbides and the like is a little. The invention has further revealed that the fine carbides and the like even in a small amount can interrupt the displacement of a domain wall depending on the size of the carbides and the like, thereby degrading the magnetic properties, significantly affecting the coercive force, which is an index of power consumption of, especially, an electromagnetic component.

In the present invention, the influence on the magnetic properties is considered to change with respect to the thickness of the carbides and the like of 0.4 μm as the border. The thickness of 0.4 μm is a value calculated in the following way. First, the width δ of a domain wall of the pure-iron based soft magnetic steel can be calculated from a physical property value of pure iron and by the formula (2) below, to be as follows: 0.037 μm≈0.04 μm.

δ=γ/(2K) (2)

where γ is energy per unit area of the domain wall, a value of γ being 3.6×10⁻³ J/m²; and

K is a magnetic anisotropy energy coefficient, a value of K being 48×10³ J/m³ (from: “Introduction to Magnetism”, edited by Masayuki SHIGA, Uchida Rokakuho Publishing Co.).

When the thickness of the carbides and the like is substantially matched to the width of the domain wall, the carbides and the like serve as pinning sites that are strong for the displacement of the domain wall. A pinning force is exhibited even though the thickness of the carbides and the like is increased. Specifically, until the thickness of the carbides and the like reaches approximately ten times the width of the above-mentioned domain wall, namely, 0.4 μm, the pinning force can be considered to have any influence. In the present invention, the content of carbides or the like having a thickness of less than 0.4 μm (hereinafter sometimes referred to as “small-sized carbides and the like”) is reduced as much as possible, and the carbides and the like having a thickness of 0.4 μm or more (hereinafter sometimes referred to as “large-sized carbides and the like”) are sufficiently precipitated with respect to the C content in the steel. That is, the content of small-sized carbides and the like that adversely affect the magnetic properties is reduced, and large-sized carbides and the like that do not adversely affect the magnetic properties and magnetic aging characteristics are positively precipitated to reduce the solid-solution C and sold-solution N, thereby enabling improvement of the magnetic aging characteristics. The solid-solution C and solid-solution N are fixed as the carbides and the carbonitrides in the stage of steel, that is, before forming a component, thus suppressing the magnetic aging that would otherwise occur when the temperature of the component is increased from room temperature to about 200° C. due to heat generation in the use of the component. Note that the term “thickness of the carbides and the like” as used in the present invention means a minor axis of the carbides and the like.

Specifically, carbides and the like that have a thickness of less than 0.4 μm have an area ratio of 0.20 area % or less. In this way, the area ratio of the small-sized carbides and the like is made smaller, which can prevent the adverse effect on the magnetic properties. The area ratio is preferably 0.1 area % or less, and may be 0 area %.

An area ratio M of carbides and the like having a thickness of 0.4 μm or more satisfies the relationship of the formula (1) below.

F=M−20×[C]>0 (1)

In the formula (1), [C] means a C content in percent by mass in the soft magnetic steel. Experiments are performed using steels having various C contents by changing areas of carbides and the like, resulting in the above-mentioned formula (1). In this way, the area ratio of the large-sized carbides and the like is increased with respect to the C content in the steel, leading to sufficient precipitation of the carbides and the like, which become large-sized ones that do not adversely affect the magnetic properties. Thus, the content of solid-solution C and solid-solution N in the steel can be decreased, thereby improving the magnetic aging characteristics. The area ratio of large-sized carbides and the like preferably satisfies the formula (1-2) below, and more preferably satisfies the formula (1-3) below. In each of the formulas (1-2) and (1-3) below, [C] means a C content in percent by mass in a soft magnetic steel.

F₂=M−25×[C]>0 (1-2)

F₃=M−30×[C]>0 (1-3)

The more area ratio of large-sized carbides and the like having a thickness of 0.4 μm or more are preferable in terms of obtaining the excellent magnetic aging characteristics. It is ideal that all amounts of C in the steel preferably become carbides but can adversely affect the cold forgeability, in addition to the difficulty in industrial production. Thus, the upper limit of the area ratio of the carbides and the like is preferably 2.5 area %. An area ratio of 2.5 area % is equivalent to a value obtained by multiplying the upper limit of C content of 0.025% in the present invention by 100.

The thickness of the large-sized carbides and the like is preferably 1.0 μm or more. That is, instead of the area ratio M of the above-mentioned formula (1), the area ratio M₂ of carbides and the like having a thickness of 1.0 μm or more preferably satisfies the above formula (1), and satisfies more preferably the above formula (1-2) and further preferably the formula (1-3). The upper limit of thickness of the large-sized carbides and the like is normally approximately 12 μm. However, by taking into consideration suppression of the adverse effect on the cold forgeability, the upper limit of thickness of the large-sized carbides and the like is preferably approximately 5 μm, more preferably 3.0 μm, and further preferably 2.0 μm. The upper limit of thickness of the large-sized carbides and the like can be adjusted, for example, by controlling the time from hot-rolling to quenching (to be mentioned later), especially, by controlling the time after winding the wire rod to quenching.

The soft magnetic steel of the present invention preferably has a ferrite single phase composition. A two-phase composition of ferrite and pearlite and the like enhances the coercive force of the soft magnetic steel, reduces the magnetic flux density thereof, and degrades the magnetic properties thereof. The expression “ferrite single phase composition” as used herein means that a ferrite composition occupies 95 area % or more of the whole composition, preferably 98 area % or more, and more preferably 100 area %. Note that the area ratio is measured by a scanning electron microscope (SEM).

The soft magnetic steel in the present invention preferably has the crystal grain size number of 2.0 to 7.0. Any excessive small crystal grain size of the steel causes the crystal grain boundary to significantly affect and interrupt the displacement of the domain wall, leading to an increase in coercive force of the steel. Thus, preferably, the crystal grain size is increased, the existence density of the crystal grain boundary is decreased, and the ferrite crystal grain size number is preferably 7.0 or less, and more preferably 6.0 or less. The larger crystal grain size is preferable in terms of achieving the higher magnetic properties, but is difficult to attain in terms of industrial productivity. If the crystal grain is excessively coarsened, the ductility and toughness of the steel are reduced, thus worsening the cold forgeability. The ferrite crystal grain size number is preferably 2.0 or more, and more preferably 3.0 or more.

When forming the steel into a component, parts of the component with different crystal grain sizes would result in non-uniform magnetic properties across the component. For this reason, a difference in crystal grain size number across the superficial layer to the inside of the steel is preferably restricted within 1.0.

The element compositions of the soft magnetic steel in the present invention will be described below.

### C: 0.001 to 0.025%

Carbon (C) is an element essential to ensure the mechanical strength of the steel. Even a small content of C can suppress the degradation of the magnetic properties due to eddy current by an increasing effect of electric resistance. As mentioned above, in the present invention, carbides and the like are precipitated to achieve the reduction in amount of solid-solution C. However, if the C content is small, the effect of improving the magnetic aging characteristics owing to reduction in the solid-solution C is still saturated. Here, the C content is set at 0.001% or more. The C content is preferably 0.003% or more, more preferably 0.005% or more, and further preferably 0.007% or more. However, C is solid-soluted in the steel to distort a Fe crystal lattice, thereby degrading the magnetic properties of the steel, and further it is diffused during use, thereby promoting the magnetic aging to degrade the magnetic properties. Accordingly, the C content is set at 0.025% or less, preferably 0.020% or less, and more preferably 0.015% or less.

### Mn: 0.1 to 1.0%

Manganese (Mn) is an element that effectively serves as a deoxidizing agent, and contributes to improving the machinability of the steel as Mn bonds with S contained in the steel to be dispersed as fine MnS precipitates and acts as a chip breaker for chips generated during a cutting process. To effectively exhibit such effects, the Mn content is set at 0.1% or more. Thus, the Mn content is preferably 0.15% or more, and more preferably 0.20% or more. Any excessive Mn content increases the number of MnS that would adversely affect the magnetic properties. For this reason, the Mn content is set at 1.0% or less. Accordingly, the Mn content is preferably 0.8% or less, more preferably 0.60% or less, and further preferably 0.40% or less.

### P: Exceeding 0% and 0.03% or Less

Phosphorus (P) is a hazardous element that causes the segregation of grain boundaries in the steel to adversely affect the cold forgeability as well as the magnetic properties. Accordingly, the P content is restricted to 0.03% or less to improve the magnetic properties. The P content is preferably 0.015% or less, and more preferably 0.010% or less. The smaller content of P is more preferable, but normally the P content is approximately 0.001%.

### S: Exceeding 0% and 0.1% or Less

Sulfur (S) acts to form MnS in the steel as mentioned above, and to become a stress concentration site when a load is applied thereto during the cutting process, thereby improving the machinability. To effectively exhibit such effects, the S content may be 0.003% or more, and more preferably 0.01% or more. However, any excessive S content increases the number of MnS that would be hazardous to the magnetic properties, and drastically degrades the cold forgeability. Accordingly, the S content is set at 0.1% or less. The S content is preferably 0.05% or less, and more preferably 0.030% or less.

### Al: Exceeding 0% and 0.010% or Less

Aluminum (Al) is an element that is added as a deoxidizing agent and has an effect of reducing the amount of impurities together with the deoxidization to thereby improve the magnetic properties of the steel. To exhibit this effect, the Al content is preferably 0.001% or more, and more preferably 0.002% or more. Although Al serves to fix the solid-solution N that is hazardous to the magnetic properties, as AlN, to improve the magnetic properties, such as a magnetic moment, Al acts to make the crystal grains finer to increase the crystal grain boundaries, thus degrading the magnetic properties of the steel. Addition of excessive Al leads to an increase in deformation resistance of the steel, worsening the cold forgeability. Accordingly, the Al content is set at 0.010% or less. To ensure the more excellent magnetic properties, the Al content is preferably 0.008% or less, and more preferably 0.005% or less.

### N: Exceeding 0% and 0.01% or Less

As mentioned above, nitrogen (N) bonds with Al to form AlN, thus impairing the magnetic properties of the steel. Further, N elements other than those fixed by Al or the like remain as the solid-solution N in the steel, which also degrades the magnetic properties and the magnetic aging characteristics. Thus, the N content is to be suppressed as much as possible. In the present invention, the upper limit of N content is set at 0.01% that makes it possible to substantially suppress the above-mentioned adverse effects due to the presence of N to a neglectable level while considering actual processes in manufacturing the steel. The N content is preferably 0.0080% or less, more preferably 0.0060% or less, further preferably 0.0040% or less, and particularly preferably 0.0030% or less. The smaller content of N is more preferable, but normally the N content is approximately 0.0010%.

The basic components of the soft magnetic steel in the present invention have been mentioned above, with the balance being iron and inevitable impurities. The inevitable impurities are elements allowed to be trapped into the steel, depending on raw material, building materials, manufacturing equipment, etc. In addition to the elements mentioned above,

(a) at least one of Si: 0.001 to 4.0% and Cr: 0.01 to 4.0% is contained in the steel, thereby enabling improvement of the magnetic properties of the steel;
(b) when using Nb, Ti must be used together with Nb as one condition, a combination of B: 0.0003 to 0.01%, Ti: 0.001 to 0.05%, and Nb: 0.001 to 0.02% is contained in the steel, or alternatively, B and Ti are separately contained in the steel, thereby enabling the improvement of the magnetic aging characteristics and cold forgeability; and
(c) Pb: 0.01 to 1.0% is contained in the steel, thereby enabling the improvement of the machinability.

At least one of the following elements, namely, Si, Cr, B, Ti, Nb, and Pb can be contained in the steel together with the above-mentioned basic components. The respective elements will be described in detail below.

### Si: 0.001 to 4.0%

Silicon (Si) is an element serving as a deoxidizing agent when smelting the steel. Further, Si serves to increase the electric resistance of the steel to thereby suppress the degradation of the magnetic properties due to the eddy current. From this aspect, the Si content is preferably 0.001% or more, more preferably 0.01% or more, further preferably 0.1% or more, particularly preferably 1.0% or more, and most preferably 1.4% or more. However, a high content of Si degrades the cold forgeability. Accordingly, the upper limit of Si content is preferably set at 4.0%. The Si content is more preferably 3.6% or less, further preferably 3.0% or less, particularly preferably 2.8% or less, and most preferably 2.5% or less.

### Cr: 0.01 to 4.0%

Chrome (Cr) is an element that is effective in increasing an electric resistivity of a ferrite phase and decreasing a damping time constant of the eddy current. Further, Cr has effects of acting as a carbide formation element and reducing the amount of solid-solution C. To sufficiently exhibit these effects, the Cr content is preferably 0.01% or more, more preferably 0.05% or more, further preferably 0.1% or more, and particularly preferably 1.0% or more. However, any excessive Cr content degrades the magnetic properties of the steel and additionally increases an alloying cost, which fails to provide the inexpensive steel. Accordingly, the Cr content is preferably 4.0% or less, more preferably 3.6% or less, further preferably 3.0% or less, and particularly preferably 2.0% or less. Si and Cr may be respectively used separately or in combination.

### B: 0.0003 to 0.01%

Boron (B) is an element that has a strong affinity for N and can fix the solid-solution N in the form of BN, thereby effectively suppressing the magnetic aging. To sufficiently exhibit such an effect, B is preferably 0.0003% or more, more preferably 0.001% or more, and further preferably 0.002% or more. However, any excessive B content causes precipitation of a compound, such as Fe₂B, at a grain boundary, thus impairing the hot ductility of the steel. Accordingly, the B content is preferably 0.01% or less. The B content is more preferably 0.005% or less, and further preferably 0.003% or less.

### Ti: 0.001 to 0.05%,

Titanium (Ti) is an element that has a strong affinity for N, like B as mentioned above, and can fix the solid-solution N in the form of TiN, thereby effectively suppressing the magnetic aging. To sufficiently exhibit such an effect, the Ti content is preferably 0.001% or more, more preferably 0.005% or more, further preferably 0.01% or more, and particularly preferably 0.02% or more. However, any excessive Ti content tends to easily form fine precipitates of TiC, leading to an increase in strength of the material, and also tends to exhibit variations in strength of a rolled material. Thus, it is difficult to enhance the size accuracy in the cold forging process, and further the excessive Ti serves to interrupt the displacement of the domain wall, degrading the magnetic properties of the steel. Accordingly, the Ti content is preferably 0.05% or less, and more preferably 0.04% or less.

### Nb: 0.001 to 0.02%

Niobium (Nb) is an element that has a strong affinity for N, like B and Ti as mentioned above, and can fix the solid-solution N in the form of NbN, thereby effectively suppressing the magnetic aging. In particular, addition of a combination of Nb and Ti exhibits its effect. To sufficiently exhibit such an effect, the Nb content is preferably 0.001% or more. Accordingly, the Nb content is more preferably 0.005% or more, further preferably 0.008% or more, and particularly preferably 0.01% or more. On the other hand, any excessive Nb content makes it easier to form fine precipitates of NbC and (Ti, Nb)C, reducing the cold forgeability, and degrading the magnetic properties of the steel. Accordingly, the Nb content is preferably 0.02% or less, more preferably 0.017% or less, and further preferably 0.015% or less.

The above-mentioned B and Ti may be separately used, or alternatively B, Ti, and Nb may be used in combination as appropriate. When using Nb, Nb should be used together with Ti.

### Pb: 0.01 to 1.0%

Lead (Pb) acts to form Pb particles in the steel, which are softened and melted with heat generated in the cutting process. Thus, Pb has effects of serving as a stress concentration site when a load is applied thereto, thereby improving the machinability, such as chip partibility, while serving as a lubricating material for a cut surface, thereby reducing the wear volume of a tool. Thus, Pb is the element suitable for use in applications, especially, requiring the machinability. The applications include maintaining the high accuracy of the cut surface even by heavy cutting, and improving the chip processability. To effectively exhibit these effects, the Pb content is preferably 0.01% or more, and more preferably 0.05% or more. On the other hand, any excessive Pb content drastically degrades the magnetic properties and cold forgeability of the steel. Thus, the Pb content is preferably 1.0% or less. Accordingly, the Pb content is more preferably 0.50% or less, and further preferably 0.30% or less.

The soft magnetic steel in the present invention is characterized by appropriately adjusting the chemical compositions and further by controlling the area ratios of the carbides and the like depending on their sizes as mentioned above. To manufacture such a steel, in a series of steps which involves smelting the steel with the above-mentioned chemical composition by a normal smelting method, forging, and hot-rolling, it is preferable to control hot-rolling conditions, such as a heating temperature and a finish rolling temperature, and cooling conditions after the hot rolling as appropriate. The invention aims to achieve the component obtained by processing the steel, which exhibits the excellent magnetic properties even without performing magnetic annealing. To achieve this aim, control of the carbides and the like, and control of crystal grain sizes as the preferable requirement need to be performed in the stage of a hot-rolled material.

### Heating Temperature in Hot-Rolling: 950 to 1,200° C.

To completely solid-solute alloy components of the steel in a mother phase, it is desirable to heat the steel at a high temperature. However, heating at an excessively high temperature remarkably coarsens ferrite crystal grains in parts of the steel. More specifically, austenite crystal grains are coarsened during heating, and in the ferrite composition after the rolling, fine particles and coarse grains partially become prominent, whereby the cold forgeability are degraded in forming the component. Therefore, the heating temperature is preferably 1,200° C. or less, more preferably 1150° C. or less, and further preferably 1,100° C. or less. On the other hand, heating at an excessively low temperature might locally form a ferrite phase to cause cracks during the rolling process. Further, a load on a roll during the rolling process is increased, thus increasing the burden of facility and reducing the productivity. Therefore, the heating temperature is preferably 950° C. or higher, more preferably 1,000° C. or higher, and further preferably 1,050° C. or higher.

### Finish Rolling Temperature: 850° C. or Higher

When a finish rolling temperature in the hot-rolling is excessively low, the metal composition is more likely to be made finer, leading to occurrence of partially abnormal grain growth (GG) during the following cooling process. The abnormal GG occurrence part causes the rough surface of the steel in the cold forging and variations in magnetic properties of the steel. To regulate the crystal grain size, the finish rolling temperature is preferably set at 850° C. or higher, more preferably 875° C. or higher, and further preferably 900° C. or higher. The upper limit of finish rolling temperature depends on the heating temperature before the above-mentioned hot rolling process, but is approximately 1,100° C.

Cooling Rate after Hot-Rolling

As mentioned in the above Patent Document 2 and the like, in the related art, the cooling rate after the hot-rolling is set at 0.5 to 10° C./sec in a temperature range of 800 to 500° C. by taking into consideration the reduction in atomic vacancies in the mother phase and the productivity of the steel. In contrast, in the present invention, in order to suppress the precipitation of small-sized carbides and the like and to positively precipitate large-sized carbides and the like, crystal grains having a high diffusion rate are to be formed in a large amount, and carbides and the like are to be precipitated mainly due to grain boundary diffusion. Thus, cooling after the hot-rolling is performed in two stages, namely, quenching, and slow cooling or keeping a certain temperature (both being collectively referred to as the “slow cooling and the like”). In the quenching process, the austenite-to-ferrite transformation occurs at a low temperature for a short time to thereby form a ferrite grain boundary. Then, in the sequent slow cooling and the like, the solid-solution C is precipitated as the large-sized carbides and the like while utilizing grain boundaries where the diffusion rate is high.

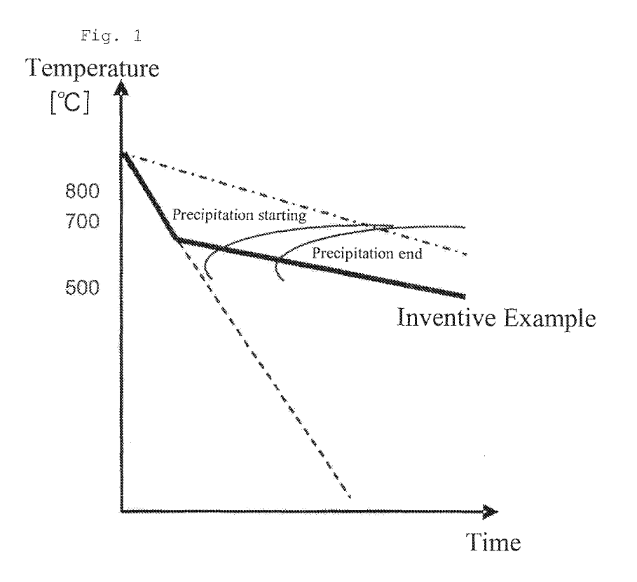

A manufacturing method for the soft magnetic steel in the present invention will be described using FIG. 1. FIG. 1 schematically shows the influences of the time and temperature of steel after the hot-rolling on precipitation of carbides and the like. In the temperature range of 700 to 500° C., a precipitation range of the carbides and the like is present. Carbides and the like are precipitated during a period of time after the temperature of the steel intersects a precipitation starting line until it intersects a precipitation end line as shown in FIG. 1. Suppose that the steel undergoes this temperature range at a certain cooling rate in the related art, for example, when the steel temperature passes at a given high cooling rate as indicated by a dotted line in FIG. 1, the steel temperature does not intersect the precipitation starting line of carbides and the like. On the other hand, when the steel temperature passes at a given low cooling rate as indicated by an alternate long and short dash line in FIG. 1, an interval between the precipitation starting line and the precipitation end line of carbides and the like is narrow. In either case, carbides and the like cannot be precipitated in sufficient amounts. In contrast, in the manufacturing method (as indicated by a thick line of FIG. 1) of the present invention, first, the steel temperature is decreased to a point close to a nose of the precipitation starting line by quenching. Then, the steel temperature can pass slowly through between the precipitation starting line and the precipitation end line by slow cooling and the like, resulting in precipitation of a sufficient amount of large-sized carbides and the like.

Quenching is processing that involves cooling the steel to a temperature of 700 to 500° C. at a cooling rate of 4 to 10° C./sec for 10 to 100 seconds after the hot-rolling. The above-mentioned cooling rate means an average cooling rate, and the same goes for the following description. If the quenching time is less than 10 seconds, the steel cannot be sufficiently cooled to the temperature range of 700 to 500° C. because of the shortage of time. If the quenching time exceeds 100 seconds, crystal grains are partially coarsened to reduce the crystal grain boundaries, degrading the productivity. Therefore, the quenching time is preferably 10 seconds or more, more preferably 20 seconds or more, and further preferably 30 seconds or more, while the quenching time is preferably 100 seconds or less, more preferably 90 seconds or less, and further preferably 80 seconds or less. When the cooling rate exceeds 10° C./sec, or when the cooling rate is less than 4° C./sec, it takes much time to start precipitation of carbides and the like due to the following slow cooling and the like, thereby degrading the productivity. In particular, the slow cooling of the steel at a cooling rate of less than 4° C./sec for an adequate time after the hot-rolling also enables precipitation of the carbides and the like, which results in an increase in thickness of the carbides and the like, adversely affecting the cold forgeability. Therefore, the cooling rate is preferably 4° C./sec or more, more preferably 5° C./sec or more, and further preferably 6° C./sec or more, while the cooling rate is preferably 10° C./sec or less, more preferably 9° C./sec or less, and further preferably 8° C./sec or less.

The slow cooling or processing for keeping the temperature constant, following the quenching, is a precipitation process step of carbides and the like that is required to stably precipitate the carbides and the like as mentioned above. If the time for the precipitation process of the carbides and the like is less than 100 seconds, the carbides and the like are not precipitated in the adequate amounts. The time for the precipitation process of the carbides and the like is preferably 100 seconds or more, more preferably 150 seconds or more, and further preferably 200 seconds or more. The upper limit of the time for the precipitation process of the carbides and the like is not particularly limited, but approximately 1,000 seconds when considering the productivity. The precipitation process of the carbides and the like is preferably performed while being held at a constant temperature. However, the cooling rate of less than 1.0° C./sec does not affect the precipitation of the carbides and the like. The cooling rate is more preferably 0.8° C./sec or less, and further preferably 0.5° C./sec or less.

Specific means for the above-mentioned quenching and precipitation process of carbides and the like involves, when the steel is formed into a wire rod, for example, adjusting a conveyor speed to take a gap between a dense portion and a non-dense portion of the wire rod on the conveyor, and blowing air toward the dense portion and the non-dense portion by an appropriate force. Alternatively, the wire rod is quenched by being immersed in water bath, oil bath, salt bath, etc., having its temperature adjusted, and then it is allowed to be carried over a conveyor while passing through a heater cover positioned on the conveyor. Further, alternatively, the wire rod is immersed in salt bath. In this way, the precipitation process of carbides and the like can be conducted. When using a steel sheet as the steel, the steel sheet obtained after the finish-rolling is quenched by water cooling or mist cooling to a temperature range of 700 to 500° C., and then such a hot-rolled steel coil was held in an annealing furnace at 700 to 500° C., thus undergoing the precipitation process of carbides and the like. Alternatively, a continuous annealing line is installed to perform annealing on the steel after the hot rolling. In this way, the above-mentioned quenching and precipitation process of carbides and the like can be conducted. Further, when using a steel bar as the steel, the steel bar is quenched by being immersed in water bath, oil bath, salt bath, etc., or quenched by water cooling or mist cooling to a temperature range of 700 to 500° C., and then such a steel bar is held at a cooling bed or in an annealing furnace at 700 to 500° C. In this way, the precipitation process of carbides and the like can be conducted.

After the end of the precipitation process of carbides and the like, cooling conditions are not particularly limited. For example, air cooling may be performed.

To regulate the crystal grain size of the soft magnetic steel to meet the preferable requirements in the present invention, the following manufacturing conditions are preferably employed.

When the soft magnetic steel is a wire rod, a winding temperature after the hot-rolling is preferably set at 800° C. or higher. If the winding temperature is low, a microstructure tends to be made finer, like the above-mentioned finish rolling temperature, thus degrading both the cold forgeability and the magnetic properties. Accordingly, the winding should be completed preferably at 800° C. or higher, and more preferably 850° C. or higher. The upper limit of the winding temperature depends on the finish rolling temperature mentioned above, but is approximately 975° C. That is, when using the wire rod, the hot-rolling is performed at the above-mentioned heating temperature and finish rolling temperature as the preferable requirements, and then the winding is completed at 800° C. or higher, followed by cooling for 10 to 100 seconds at a cooling rate of 4 to 10° C./sec, and quenching to 700 to 500° C. Subsequently, the precipitation process of carbides and the like, which involves decreasing the cooling rate to less than 1.0° C./sec or keeping the temperature constant, should be performed in a temperature range of 700 to 500° C. for 100 seconds or more.

When the soft magnetic steel is a steel bar or sheet, a heating temperature in the hot-rolling is preferably set at 950 to 1,200° C. When the heating temperature is excessively high, disadvantageously, the ferrite crystal grains are partially coarsened, thus degrading the cold forgeability in forming the component. Accordingly, the heating temperature in hot-rolling is preferably 1,200° C. or lower, more preferably 1150° C. or lower, and further preferably 1,100° C. or lower. On the other hand, when the heating temperature is excessively low, the crystal grains are made finer, thus degrading the magnetic properties. Additionally, the ferrite phase can be locally formed to cause rolling cracks. Accordingly, the heating temperature is preferably set to 950° C. or higher, more preferably 1,000° C. or higher, and further preferably 1,050° C. or higher.

The invention also includes soft magnetic components that are obtained by cold-working the above-mentioned soft magnetic steel. Such soft magnetic components have the same composition as that of the soft magnetic steel and can further be obtained by cold-working. Thus, the soft magnetic components can maintain the precipitation state and microstructure of the carbides and the like of the above-mentioned soft magnetic steel. This kind of soft magnetic component can achieve the excellent magnetic properties even if the magnetic annealing process is omitted. Examples of the soft magnetic component can include iron core materials, such as an electromagnetic valve, a solenoid, and a relay, magnetic shield materials, actuator members, and motor and sensor members, used in various electromagnetic components, including soft magnetic components for automobiles, trains, ships, etc.

This application claims priority on Japanese Patent Application No. 2013-248384 filed on Nov. 29, 2013, and Japanese Patent Application No. 2014-099410 filed on May 13, 2014, the disclosure of which is incorporated by reference herein.

### EXAMPLES

The present invention will be specifically described below by way of examples. The present invention is not limited to the following examples. It is obvious that various modifications can be made to these examples as long as they are adaptable to the above-mentioned and below-mentioned concepts, and are included within the technical scope of the present invention.

A steel having an element composition shown in Table 1 was smelted by a normal smelting method and forged. Thereafter, under the conditions shown in Table 2, the hot-rolling and cooling were performed to produce a steel having a diameter of 20 mm, that is, a rolled material. That is, the hot-rolling was performed at the heating temperature and the finish temperature mentioned in Table 2, and then the rolled material was completely wound at a winding temperature mentioned in Table 2. Thereafter, the quenching and slow cooling processes were performed on the wound steel under the conditions mentioned in Table 2. Note that the balance of the element composition shown in Table 1 includes iron and inevitable impurities. The most rightward column in Table 2 shows conditions for quenching, including a cooling rate and a cooling time from the finish temperature to the slow-cooling starting temperature, into which the quenching conditions are converted. Regarding the obtained steels, microstructure inspection, measurement of carbides and the like, and evaluation of the cold forgeability, magnetic properties, and magnetic aging characteristics were performed in the following ways.

TABLE 1

| | Chemical composition (% by mass) | | | | | | | | | | | |
|---|---|---|---|---|---|---|---|---|---|---|---|---|
| Steel No. | C | Si | Mn | P | S | Cr | Al | N | B | Ti | Nb | Pb |
| K01 | 0.005 | — | 0.25 | 0.008 | 0.006 | — | 0.004 | 0.0023 | | — | — | — |
| K02 | 0.009 | 0.010 | 0.24 | 0.005 | 0.004 | 0.02 | 0.002 | 0.0028 | — | — | — | — |
| K03 | 0.004 | — | 0.26 | 0.008 | 0.027 | — | 0.002 | 0.0032 | — | — | — | — |
| K04 | 0.009 | 0.005 | 0.23 | 0.009 | 0.025 | 0.02 | 0.002 | 0.0028 | — | — | — | — |
| K05 | 0.005 | 0.185 | 0.22 | 0.002 | 0.018 | 0.03 | 0.001 | 0.0076 | — | — | — | 0.10 |
| K06 | 0.010 | 2.740 | 0.29 | 0.006 | 0.020 | 0.07 | 0.004 | 0.0040 | — | — | — | 0.08 |
| K07 | 0.004 | 1.990 | 0.24 | 0.003 | 0.023 | — | 0.003 | 0.0022 | — | — | — | — |
| K08 | 0.003 | 2.670 | 0.26 | 0.004 | 0.004 | — | 0.004 | 0.0019 | — | — | — | — |
| K09 | 0.007 | 0.008 | 0.22 | 0.006 | 0.010 | 0.02 | 0.003 | 0.0042 | — | 0.035 | — | — |
| K10 | 0.017 | 0.240 | 0.39 | 0.009 | 0.007 | 0.03 | 0.010 | 0.0032 | — | 0.011 | 0.0170 | — |
| K11 | 0.003 | 2.070 | 0.25 | 0.003 | 0.004 | 1.58 | 0.006 | 0.0032 | — | — | — | — |
| K12 | 0.012 | 2.000 | 0.24 | 0.005 | 0.003 | 1.50 | 0.003 | 0.0054 | — | — | — | — |
| K13 | 0.007 | 1.970 | 0.23 | 0.003 | 0.005 | — | 0.004 | 0.0017 | — | — | — | — |
| K14 | 0.007 | 1.960 | 0.23 | 0.004 | 0.005 | 3.10 | 0.006 | 0.0022 | — | — | — | — |
| K15 | 0.009 | 0.005 | 0.31 | 0.012 | 0.009 | — | 0.002 | 0.0032 | 0.0011 | — | — | — |
| K16 | 0.018 | 0.002 | 0.10 | 0.006 | 0.003 | — | 0.002 | 0.0023 | 0.0022 | — | — | — |
| K17 | 0.005 | — | 0.11 | 0.007 | 0.007 | — | 0.003 | 0.0011 | — | — | — | — |
| K18 | 0.020 | 0.150 | 0.38 | 0.012 | 0.012 | — | 0.009 | 0.0042 | 0.0008 | 0.022 | — | — |
| K19 | 0.005 | 0.010 | 0.40 | 0.003 | 0.004 | 3.54 | 0.003 | 0.0023 | — | — | — | — |
| K20 | 0.006 | 0.020 | 0.64 | 0.011 | 0.009 | 2.00 | 0.006 | 0.0052 | — | 0.010 | — | — |
| K21 | 0.012 | 0.060 | 0.52 | 0.009 | 0.008 | 0.11 | 0.008 | 0.0042 | 0.0030 | — | — | — |
| K22 | 0.003 | 3.500 | 0.25 | 0.004 | 0.003 | 0.01 | 0.004 | 0.0022 | — | — | — | — |
| K23 | 0.024 | 1.960 | 0.23 | 0.004 | 0.005 | 0.01 | 0.006 | 0.0022 | — | — | — | — |
| K24 | 0.005 | — | 0.90 | 0.007 | 0.005 | — | 0.003 | 0.0040 | — | — | — | — |
| K25 | 0.006 | 1.480 | 0.27 | 0.003 | 0.004 | 0.01 | 0.003 | 0.0021 | — | — | — | — |
| L01 | 0.070 | 3.010 | 0.34 | 0.018 | 0.013 | 0.02 | 0.052 | 0.0039 | — | — | — | — |
| L02 | 0.021 | 2.460 | 0.49 | 0.014 | 0.047 | 3.19 | 4.170 | 0.0062 | — | — | — | — |
| L03 | 0.020 | 2.510 | 0.51 | 0.015 | 0.046 | 3.14 | 4.860 | 0.0016 | — | — | — | — |
| L04 | 0.005 | 2.420 | 0.25 | 0.006 | 0.004 | 3.16 | 4.400 | 0.0011 | — | — | — | — |
| L05 | 0.108 | 0.180 | 0.48 | 0.013 | 0.015 | 0.08 | 0.024 | 0.0022 | — | — | — | — |
| L06 | 0.140 | 0.010 | 0.35 | 0.016 | 0.004 | 0.02 | 0.047 | 0.0044 | — | — | — | — |
| L07 | 0.005 | 6.030 | 0.23 | 0.004 | 0.003 | 0.01 | 0.005 | 0.0021 | — | — | — | — |
| L08 | 0.007 | 2.984 | 0.31 | 0.011 | 0.006 | 7.26 | 0.014 | 0.0046 | — | 0.011 | — | — |
| L09 | 0.007 | 0.330 | 0.35 | 0.041 | 0.278 | 19.14 | 0.002 | 0.0180 | — | 0.006 | — | 0.12 |
| L10 | 0.021 | 2.480 | 0.50 | 0.003 | 0.033 | 1.70 | 0.085 | 0.0317 | — | 0.002 | — | — |
| L11 | 0.007 | — | 2.20 | 0.006 | 0.100 | — | 0.002 | 0.0030 | — | — | — | — |

With the balance being iron and inevitable impurities

TABLE 2

| | | Manufacturing conditions | | | | | | | | | | |
|---|---|---|---|---|---|---|---|---|---|---|---|---|
| | | | | | | | | | | | Quenching (in | |
| | | | | | | | Slow- | | | Time after | terms of a value | |
| | | | | | | | cooling | | | starting slow- | differing from a | |
| | | Heating | Finish | Winding | Quenching | | starting | Slow- | Slow- | cooling until | finish temperature) | |
| Exper- | | temper- | temper- | temper- | Cooling | Cooling | temper- | cooling | cooling | 500° C. or | Cooling | Cooling |
| iment | Steel | ature | ature | ature | rate | time | ature | rate | time | higher is reached | rate | time |
| No | No. | [° C.] | [° C.] | [° C.] | [° C./sec] | [sec] | [° C.] | [° C./sec] | [sec] | [sec] | [° C./sec] | [sec] |
| 1 | K01 | 1,000 | 950 | 900 | 5.6 | 36 | 700 | 0.4 | 480 | 480 | 4.9 | 51 |
| 2 | K02 | 1,000 | 950 | 850 | 6.9 | 36 | 600 | 0.3 | 600 | 300 | 6.9 | 51 |
| 3 | K03 | 1,100 | 950 | 850 | 6.9 | 36 | 600 | 0.3 | 400 | 400 | 6.9 | 51 |
| 4 | K04 | 1,000 | 950 | 900 | 5.6 | 36 | 700 | 0.4 | 600 | 480 | 4.9 | 51 |
| 5 | K04 | 1,000 | 950 | 850 | 6.9 | 36 | 600 | 0.3 | 320 | 320 | 6.9 | 51 |
| 6 | K05 | 1,050 | 1,000 | 950 | 5.6 | 45 | 700 | 0.3 | 320 | 320 | 5.0 | 60 |
| 7 | K06 | 1,100 | 900 | 850 | 5.6 | 36 | 650 | 0.4 | 600 | 360 | 4.9 | 51 |
| 8 | K07 | 1,050 | 1,000 | 900 | 5.6 | 36 | 700 | 0.2 | 600 | 600 | 5.9 | 51 |
| 9 | K08 | 1,100 | 1,050 | 925 | 4.7 | 90 | 500 | 0.0 | 320 | 320 | 5.5 | 99 |
| 10 | K09 | 1,000 | 950 | 900 | 7.8 | 45 | 550 | 0.4 | 400 | 133 | 6.7 | 60 |
| 11 | K10 | 1,000 | 1,000 | 950 | 6.9 | 36 | 700 | 0.1 | 686 | 686 | 5.9 | 51 |
| 12 | K11 | 1,100 | 1,025 | 925 | 6.1 | 45 | 650 | 0.3 | 480 | 480 | 6.3 | 60 |
| 13 | K12 | 1,000 | 950 | 900 | 6.7 | 60 | 500 | 0.0 | 320 | 320 | 6.0 | 75 |
| 14 | K12 | 1,100 | 950 | 850 | 4.2 | 36 | 700 | 0.4 | 533 | 533 | 4.9 | 51 |
| 15 | K13 | 1,000 | 950 | 900 | 6.7 | 45 | 600 | 0.4 | 240 | 240 | 5.8 | 60 |
| 16 | K14 | 1,050 | 1,000 | 925 | 6.3 | 36 | 700 | 0.4 | 480 | 480 | 5.9 | 51 |
| 17 | K15 | 975 | 950 | 875 | 5.4 | 60 | 550 | 0.3 | 192 | 192 | 5.3 | 75 |
| 18 | K16 | 1,200 | 900 | 800 | 5.0 | 60 | 500 | 0.0 | 240 | 240 | 5.3 | 75 |
| 19 | K17 | 1,100 | 950 | 850 | 6.9 | 36 | 600 | 0.3 | 320 | 320 | 6.9 | 51 |
| 20 | K18 | 1,050 | 975 | 900 | 5.6 | 36 | 700 | 0.3 | 960 | 768 | 5.4 | 51 |
| 21 | K19 | 1,150 | 1,000 | 950 | 4.2 | 60 | 700 | 0.4 | 480 | 480 | 4.0 | 75 |
| 22 | K20 | 1,000 | 1,050 | 875 | 4.5 | 39 | 700 | 0.3 | 600 | 600 | 6.5 | 54 |
| 23 | K21 | 950 | 950 | 900 | 4.4 | 45 | 700 | 0.2 | 436 | 436 | 4.2 | 60 |
| 24 | K22 | 1,000 | 1,000 | 925 | 4.7 | 69 | 600 | 0.4 | 267 | 267 | 4.8 | 84 |
| 25 | K23 | 1,050 | 975 | 875 | 6.3 | 36 | 650 | 0.3 | 600 | 600 | 6.4 | 51 |
| 26 | K24 | 1,100 | 1,000 | 925 | 5.0 | 45 | 700 | 0.3 | 800 | 640 | 5.0 | 60 |
| 27 | K25 | 1,000 | 950 | 900 | 7.3 | 41 | 600 | 0.4 | 600 | 240 | 6.3 | 56 |
| 28 | K02 | 1,100 | 1,000 | 950 | 15.0 | 30 | | No slow cooling or not | | 0 | 11.1 | 45 |
| | | | | | | | | keeping temperature | | | | |
| 29 | K01 | 1,050 | 1,000 | 950 | 19.4 | 18 | 600 | 3.1 | 96 | 32 | 12.2 | 33 |
| 30 | K03 | 1,100 | 1,050 | 1,000 | 13.9 | 36 | | No slow cooling or not | | 0 | 10.8 | 51 |
| | | | | | | | | keeping temperature | | | | |
| 31 | K12 | 1,000 | 900 | 750 | 1.7 | 90 | 600 | 0.6 | 320 | 167 | 3.0 | 99 |
| 32 | K10 | 1,050 | 1,000 | 950 | 1.3 | 113 | 800 | 0.5 | 600 | 600 | 1.6 | 127 |
| 33 | K09 | 1,100 | 950 | 850 | 11.7 | 30 | | No slow cooling or not | | 0 | 10.0 | 45 |
| | | | | | | | | keeping temperature | | | | |
| 34 | L01 | 1150 | 1,000 | 900 | 8.3 | 36 | 600 | 1.0 | 192 | 100 | 7.9 | 51 |
| 35 | L02 | 1,000 | 900 | 850 | 5.6 | 45 | 600 | 0.4 | 240 | 240 | 5.0 | 60 |
| 36 | L03 | 1,100 | 950 | 900 | 4.4 | 45 | 700 | 0.4 | 240 | 240 | 4.2 | 60 |
| 37 | L04 | 1,250 | 1150 | 1,000 | 4.4 | 90 | 600 | 0.2 | 480 | 480 | 5.5 | 99 |
| 38 | L05 | 1,000 | 950 | 850 | 4.2 | 60 | 600 | 0.3 | 320 | 320 | 4.7 | 75 |
| 39 | L06 | 1,050 | 1,000 | 950 | 1.3 | 113 | 800 | 0.2 | 600 | 600 | 1.6 | 127 |
| 40 | L07 | 1,200 | 1,100 | 950 | 6.9 | 36 | 700 | 0.3 | 192 | 192 | 7.9 | 51 |
| 41 | L08 | 1,200 | 1,100 | 850 | 6.9 | 36 | 600 | 0.3 | 192 | 192 | 8.2 | 61 |
| 42 | L09 | 1,050 | 1,000 | 900 | 4.4 | 45 | 700 | 0.4 | 240 | 240 | 5.0 | 60 |
| 43 | L10 | 1,250 | 1,100 | 950 | 9.7 | 36 | 600 | 0.4 | 480 | 250 | 9.8 | 51 |
| 44 | L11 | 1,050 | 1,000 | 950 | 5.8 | 60 | 600 | 0.3 | 320 | 320 | 5.3 | 75 |
| 45 | K12 | 1,100 | 1,050 | 950 | 5.0 | 90 | | No slow cooling or not | | 0 | 5.5 | 99 |
| | | | | | | | | keeping temperature | | | | |
| 46 | K10 | 1,000 | 950 | 750 | 4.2 | 36 | 600 | 0.4 | 480 | 250 | 6.1 | 57 |

### (1) Evaluation of Microstructure

The above-mentioned rolled material was cut on the cross-section, which was a cross-section perpendicular to an axis, and the ¼ position of the diameter D, which was the typical microstructure of the entire rolled material, was observed with an optical microscope. In observing the microstructure, the steel was immersed in a nital corrosion solution to cause the crystal grain boundaries to appear, and the microstructure thereof were identified by being observed in three fields of view at 100 to 400-fold magnification, while the crystal grain sizes were determined in conformity with JIS G0551. An average of the crystal grain size was defined as the crystal grain size of each steel.

### (2) Measurement of Carbides and the Like

Carbides and the like were measured by using a field-emission scanning electron microscope (FE-SEM). The rolled material was cut at the cross-section and embedded in resin, followed by polishing. Then, the resin with the cut steel was immersed in a picric acid corrosion solution to cause the carbides to appear, followed by gold evaporation to thereby produce a specimen, which was used for the measurement. The area ratios of carbides and carbonitrides were determined while identifying the compositions of precipitates by an energy dispersive X-ray spectroscopy (EDS) analysis with a beam diameter focused to 0.4 μm or less. The EDS peak containing Fe and C was determined to indicate a carbide, while the EDS peak containing Fe, C, and N was determined to indicate a carbonitride. A ¼ position of the diameter D in the typical microstructure of the entire rolled material of each specimen was selected as an observation part, and observed in a range of 72 μm×95 μm in three fields of view at a 1,000-fold magnification. Based on SEM images, particles of the rolled material were analyzed to thereby determine the thickness of carbides and the like, that is, the area ratio for each minor axis. The measurement of the area ratio was performed using a commercially-available particle analysis software “particle analysis ver.3.0”. Note that the minimum thickness of the carbides and the like to be measured in Examples was 0.07 μm.

### (3) Evaluation of Cold Forgeability

Five cylindrical specimens each having φ15×22.5 mmL were sampled respectively from the above-mentioned rolled materials, and then an end face confined compression test was performed on each specimen at room temperature at a strain rate of 10/sec until the rolling reduction ratio reached 80%. A deformation resistance for use was a value determined at a rolling reduction ratio of 60% at which an increase in deformation resistance was relatively small with respect to the rolling reduction ratio. The outer appearance of each specimen after the compression test was observed with the microscopy to check the presence or absence of cracks. A crack generation rate was measured from the number of generated cracks for five specimens.

Next, evaluation methods for the magnetic properties and magnetic aging characteristics will be described. In these evaluations, it is necessary to examine the change in properties by assuming the forging and cutting of an actual product. In general, the magnetic properties are known to be significantly degraded due to the strain during forging. In Examples, the specimens for use were obtained by cutting in the cutting process. By introducing the strain upon cutting, the processing of the steel into the component was simulated to thereby evaluate the magnetic properties and magnetic aging characteristics of the component.

### (4) Evaluation of Magnetic Properties

A ring test piece having 18 mm in outer diameter, 10 mm in inner diameter, and 3 mm in thickness was fabricated from the above-mentioned rolled material of each specimen having a diameter of 20 mm. Then, the magnetic properties of the ring test piece were evaluated in conformance with JIS C2504. A excitation coil was wound 150 turns around the ring test piece, and a detection coil was wound 25 turns around it, whereby a magnetization curve was drawn at room temperature using an automatic magnetization characteristics measuring machine (manufactured by Riken Denshi Co., Ltd: BHS-40) to thereby determine a coercive force and a magnetic flux density at an applied magnetic field of 400 A/m.

### (5) Evaluation of Magnetic Aging Characteristics

The above-mentioned ring test pieces were held in the heating furnace at 200° C. for 14 days, that is, at 200° C. for 336 hours. Each of the thus-obtained ring test pieces was measured by the automatic magnetization characteristics measuring machine as mentioned above to thereby determine a coercive force and a magnetic flux density. Then, changes in coercive force and in magnetic flux density from those measured before heating in the above-mentioned process (4) were respectively determined.

The results of the above-mentioned items (1) to (5) are shown in Table 3.

TABLE 3

| | | | | | | | | | | | | | | Magnetic |
|---|---|---|---|---|---|---|---|---|---|---|---|---|---|---|
| | Area ratio of carbides | | | | | | | | Cold | | | | After 14 | aging |
| | and the like | | | | | | | | forgeability | | Magnetic | | days at | character- |
| | <0.4 | ≧0.4 | ≧1.0 | Maximum | C | | | | Defor- | Crack | properties | | 200° C. | istics |
| | μm | μm | μm | thick- | content | | Crystal | | mation | gener- | Magnetic | Coer- | Coer- | Difference |
| Exper- | Area | Area | Area | ness of | in steel | | grain | | resis- | ation | flux | cive | cive | in coer- |
| iment | ratio | ratio | ratio | carbides | [% by | | size | Compo- | tance | rate | density | force | force | cive force |
| No. | [%] | [%] | [%] | [μm] | mass] | F | FGC# | sition | [MPa] | [%] | [T] | [A/m] | [A/m] | [A/m] |
| 1 | 0.03 | 0.21 | 0.19 | 7.34 | 0.005 | 0.109 | 4.0 | F | 444 | 0 | 1.11 | 87.3 | 91.6 | 4.3 |
| 2 | 0.07 | 0.48 | 0.45 | 3.52 | 0.009 | 0.303 | 4.5 | F | 440 | 0 | 1.06 | 95.7 | 100.3 | 4.6 |
| 3 | 0.19 | 0.32 | 0.00 | 0.95 | 0.004 | 0.240 | 5.8 | F | 454 | 0 | 1.03 | 100.5 | 107.9 | 7.5 |
| 4 | 0.05 | 0.30 | 0.21 | 3.28 | 0.009 | 0.120 | 4.2 | F | 448 | 0 | 1.16 | 80.1 | 87.5 | 7.4 |
| 5 | 0.13 | 0.23 | 0.19 | 2.95 | 0.009 | 0.054 | 4.2 | F | 459 | 0 | 1.15 | 81.0 | 87.5 | 6.5 |
| 6 | 0.01 | 0.19 | 0.11 | 1.91 | 0.005 | 0.090 | 4.3 | F | 501 | 0 | 0.86 | 94.2 | 100.8 | 6.6 |
| 7 | 0.07 | 0.22 | 0.20 | 2.00 | 0.010 | 0.018 | 4.0 | F | 704 | 0 | 0.95 | 87.2 | 92.3 | 5.1 |
| 8 | 0.01 | 0.18 | 0.09 | 1.61 | 0.004 | 0.100 | 2.3 | F | 687 | 0 | 0.81 | 50.3 | 56.3 | 6.0 |
| 9 | 0.03 | 0.12 | 0.06 | 1.32 | 0.003 | 0.060 | 2.1 | F | 695 | 0 | 1.06 | 36.0 | 42.3 | 6.3 |
| 10 | 0.04 | 0.21 | 0.00 | 0.70 | 0.008 | 0.050 | 5.0 | F | 457 | 0 | 0.90 | 99.5 | 103.8 | 4.3 |
| 11 | 0.05 | 1.19 | 1.00 | 10.23 | 0.017 | 0.853 | 7.0 | F | 508 | 0 | 1.01 | 118.3 | 123.0 | 4.7 |
| 12 | 0.07 | 0.07 | 0.06 | 1.33 | 0.003 | 0.013 | 4.1 | F | 666 | 0 | 0.95 | 90.0 | 97.2 | 7.2 |
| 13 | 0.11 | 0.46 | 0.30 | 1.36 | 0.012 | 0.218 | 6.7 | F | 659 | 0 | 0.91 | 112.1 | 119.8 | 7.7 |
| 14 | 0.12 | 0.26 | 0.24 | 1.24 | 0.012 | 0.020 | 4.3 | F | 673 | 0 | 0.82 | 102.0 | 109.4 | 7.4 |
| 15 | 0.03 | 0.19 | 0.14 | 1.55 | 0.007 | 0.048 | 2.5 | F | 644 | 0 | 1.01 | 38.9 | 46.2 | 7.3 |
| 16 | 0.02 | 0.17 | 0.15 | 1.49 | 0.007 | 0.025 | 3.0 | F | 709 | 0 | 0.99 | 68.0 | 72.0 | 4.0 |
| 17 | 0.01 | 0.20 | 0.00 | 0.78 | 0.005 | 0.100 | 4.3 | F | 461 | 0 | 0.99 | 82.3 | 85.8 | 3.5 |
| 18 | 0.02 | 0.28 | 0.00 | 0.92 | 0.006 | 0.160 | 3.1 | F | 489 | 0 | 1.30 | 102.1 | 106.4 | 4.3 |
| 19 | 0.03 | 0.23 | 0.00 | 0.88 | 0.007 | 0.090 | 3.2 | F | 482 | 0 | 1.12 | 117.4 | 120.9 | 3.5 |
| 20 | 0.06 | 0.72 | 0.36 | 2.45 | 0.007 | 0.580 | 5.6 | F | 454 | 0 | 1.05 | 94.5 | 99.2 | 4.7 |
| 21 | 0.08 | 0.57 | 0.29 | 2.98 | 0.005 | 0.470 | 2.1 | F | 501 | 0 | 0.81 | 112.1 | 118.2 | 6.1 |
| 22 | 0.10 | 0.45 | 0.23 | 2.66 | 0.006 | 0.330 | 6.1 | F | 413 | 0 | 0.83 | 78.2 | 84.1 | 5.9 |
| 23 | 0.09 | 0.47 | 0.27 | 2.51 | 0.008 | 0.307 | 2.2 | F | 408 | 0 | 1.01 | 81.5 | 83.6 | 2.1 |
| 24 | 0.02 | 0.16 | 0.08 | 1.35 | 0.003 | 0.100 | 3.6 | F | 740 | 20 | 1.05 | 37.4 | 43.2 | 5.8 |
| 25 | 0.05 | 1.94 | 1.60 | 4.32 | 0.024 | 1.460 | 2.3 | F | 695 | 0 | 0.92 | 93.3 | 95.3 | 2.0 |
| 26 | 0.02 | 0.17 | 0.00 | 0.56 | 0.007 | 0.030 | 5.3 | F | 468 | 0 | 1.01 | 82.6 | 90.6 | 8.0 |
| 27 | 0.08 | 0.27 | 0.15 | 2.10 | 0.007 | 0.130 | 2.6 | F | 619 | 0 | 1.05 | 44.8 | 53.2 | 8.4 |
| 28 | 0.01 | 0.03 | 0.00 | 0.86 | 0.009 | −0.154 | 4.5 | F | 450 | 0 | 1.05 | 91.2 | 112.1 | 20.9 |
| 29 | 0.13 | 0.08 | 0.00 | 0.78 | 0.005 | −0.022 | 4.5 | F | 443 | 0 | 1.18 | 89.8 | 105.2 | 15.4 |
| 30 | 0.34 | 0.03 | 0.00 | 0.79 | 0.004 | −0.045 | 5.0 | F | 455 | 0 | 0.99 | 105.8 | 126.8 | 21.0 |
| 31 | 0.26 | 0.20 | 0.05 | 1.19 | 0.012 | −0.041 | 9.0 | F | 671 | 0 | 0.76 | 138.6 | 154.8 | 16.2 |
| 32 | 0.01 | 0.02 | 0.01 | 1.25 | 0.017 | −0.324 | 6.8 | F | 506 | 0 | 1.02 | 115.2 | 138.2 | 23.0 |
| 33 | 0.11 | 0.00 | 0.00 | 0.53 | 0.008 | −0.160 | 6.0 | F | 461 | 0 | 0.86 | 100.1 | 119.6 | 19.5 |
| 34 | 0.19 | 0.33 | 0.17 | 1.21 | 0.070 | −1.070 | 8.0 | F | 855 | 0 | 0.96 | 127.8 | 154.3 | 26.5 |
| 35 | 0.39 | 0.07 | 0.04 | 1.28 | 0.021 | −0.350 | 2.0 | F | 1110 | 40 | 0.81 | 52.1 | 74.3 | 22.2 |
| 36 | 0.21 | 0.17 | 0.09 | 2.00 | 0.020 | −0.230 | 2.1 | F | 1111 | 40 | 0.76 | 52.5 | 76.5 | 24.0 |
| 37 | 0.43 | 0.06 | 0.03 | 1.58 | 0.005 | −0.040 | −1.0 | F | 931 | 100 | 0.79 | 40.2 | 53.1 | 12.6 |
| 38 | 1.61 | 4.98 | 3.96 | 5.44 | 0.108 | 2.822 | 8.0 | F + P | 588 | 100 | 0.94 | 147.8 | 150.3 | 2.5 |
| 39 | 1.12 | 1.64 | 0.19 | 1.51 | 0.140 | −1.161 | 10.0 | F | 566 | 60 | 0.92 | 124.3 | 151.6 | 27.3 |
| 40 | 0.05 | 0.10 | 0.05 | 1.28 | 0.003 | 0.040 | −1.0 | F | 1104 | 100 | 1.22 | 20.6 | 25.8 | 5.2 |
| 41 | 0.07 | 0.05 | 0.00 | 0.39 | 0.007 | −0.090 | 1.0 | F | 739 | 100 | 0.53 | 104.0 | 125.3 | 21.3 |
| 42 | 0.01 | 0.02 | 0.00 | 0.49 | 0.007 | −0.120 | 4.7 | F | 627 | 40 | 0.28 | 214.2 | 227.8 | 13.6 |
| 43 | 0.31 | 0.25 | 0.13 | 1.92 | 0.021 | −0.170 | 3.0 | F | 760 | 40 | 0.61 | 149.2 | 168.3 | 19.1 |
| 44 | 0.03 | 0.15 | 0.00 | 0.65 | 0.007 | 0.010 | 4.5 | F | 502 | 0 | 0.71 | 131.4 | 140.2 | 9.1 |
| 45 | 0.15 | 0.03 | 0.00 | 0.52 | 0.012 | −0.211 | 5.2 | F | 673 | 0 | 0.75 | 144.0 | 162.1 | 18.1 |
| 46 | 0.08 | 0.65 | 0.43 | 4.86 | 0.017 | 0.314 | 9.1 | F | 508 | 0 | 0.95 | 124.0 | 129.2 | 5.2 |

Samples in Experiment Nos. 1 to 27 and 46 are examples of the present invention in each of which a steel satisfying a predetermined composition was manufactured by preferable manufacturing methods mentioned above. In these examples, the area ratio of the carbides and the like was controlled as appropriate. Thus, all samples in these experiments exhibited excellent cold forgeability having a deformation resistance of 750 MPa or less and a crack generation rate of 50% or less. Regarding the magnetic properties, all of these samples achieved the excellent magnetic properties having a coercive force of 125 A/m or less and a magnetic flux density of 0.80T or more. Further, in each of the samples, a change in coercive force after the heating and temperature-keeping process, that is, a difference value obtained by subtracting a coercive force before the heating and temperature-keeping process from that after the heating and temperature-keeping process was 10 A/m or less. Thus, these samples in the above-mentioned examples exhibited the excellent magnetic aging characteristics. In particular, as shown in Experiment Nos. 1 to 27, the crystal grain size was adjusted to a range of 2.0 to 7.0 as a preferable requirement, so that the samples could have a coercive force of 120 A/m or less, which could be smaller than that of Experiment No. 46 in which the steel had a crystal grain size of 9.1. Note that “F” mentioned in the “composition” column in Table 3 means that the area ratio of the ferrite composition measured by the SEM was 95 area % or more.

In contrast, in Experiment Nos. 28 to 45, samples did not satisfy the composition defined by the present invention, or not satisfy any of the preferable requirements for the manufacturing method, and thus did not satisfy the requirements for the carbides and the like, resulting in the degradation in at least one of the cold forgeability, the magnetic properties, and the magnetic aging characteristics.

In Experiment Nos. 28 and 30, with the cooling rate after the hot-rolling set very high, the steel was cooled at once to 500° C. without performing any slow cooling process and the like at 700 to 500° C. Experiment No. 33 did not undergo slow cooling and the like at 700 to 500° C. Further, in Experiment No. 29, the time for slow cooling and the like at 700 to 500° C. was short. Samples in these experiments mentioned above did not sufficiently ensure the carbides and the like of 0.4 μm or more in thickness and thus degraded their magnetic aging characteristics.

In Experiment No. 31, the cooling rate after the hot-rolling was slow, whereby the area ratio of carbides and the like of less than 0.4 μm in thickness was increased, but the content of carbides and the like of 0.4 μm or more in thickness became insufficient, thus degrading both the magnetic properties and magnetic aging characteristics. In Experiment No. 32, the cooling rate after the hot-rolling was slow, whereby the steel could not reach the temperature range of 700 to 500° C., which did not sufficiently ensure the carbides and the like of 0.4 μm or more in thickness and thus degraded their magnetic aging characteristics.

In Experiment No. 45, the slow cooling and the like was not performed after the quenching process, whereby large-sized carbides and the like were not sufficiently precipitated, degrading the magnetic properties and magnetic aging characteristics.

Experiment No. 34 used the steel containing high contents of C and Al, whereby large-sized carbides and the like were not sufficiently ensured, degrading all of the cold forgeability, the magnetic properties, and the magnetic aging characteristics of the steel. Further, in Experiment No. 34, the crystal gains were made fine, and their grain sizes did not satisfy the preferable grain size of the present invention, which caused an increase in deformation resistance. Experiment Nos. 35 and 36 used the steel containing Al in a larger content than that in Experiment 34, which increased its deformation resistance, reduced its cold forgeability, and degraded its magnetic aging characteristics, compared to Experiment No. 34.

Experiment No. 37 used the steel having a high Al content. In this example, a heating temperature before the hot rolling was high, whereby small-sized carbides and the like were precipitated in a large amount, and large-sized carbides and the like were not precipitated sufficiently, which degraded the cold forgeability, magnetic properties, and magnetic aging characteristics of the steel. Especially, the cold forgeability of the steel became deteriorated due to the high heating temperature, the very coarse crystal grains, and the crystal grain size not satisfying the preferable range of the present invention.

In Experiment No. 38, the C content was so high that the crack generation rate was increased, and the cold forgeability was degraded. Additionally, the area ratio of small-sized carbides and the like was increased, thereby degrading the magnetic properties. Note that in Experiment No. 38, the steel had a high C content, and had a two-phase composition of ferrite and pearlite at 93.4 area %. The increased area of the carbides further worsened the cold forgeability.

In Experiment No. 39, the C content and Al content were high, and the temperature of slow cooling and the like was set high, whereby small-sized carbides and the like were formed in a large amount, and the large-sized carbides and the like were formed in a small amount, which degraded both the cold forgeability and magnetic aging characteristics. Experiment No. 40 used the steel having a high Si content, which increased its deformation resistance and worsened its cold forgeability.

Experiment No. 41 used the steel having a high Cr content, which decreased its magnetic flux density, degrading the magnetic properties. Experiment No. 42 used the steel having a high Cr content and a high N content, Experiment No. 43 used the steel having a high Al content and a high N content, and Experiment No. 44 used the steel having a high Mn content. In each of these experiments, the magnetic flux density of the steel was reduced, and the coercive force thereof was increased, thus degrading the magnetic properties thereof.

1.-6. (canceled)

7. A soft magnetic steel, comprising, in percent by mass:
C: 0.001 to 0.025%;
Mn: 0.1 to 1.0%;
P: exceeding 0% and 0.03% or less;
S: exceeding 0% and 0.1% or less;
Al: exceeding 0% and 0.010% or less; and
N: exceeding 0% and 0.01% or less,
with the balance being iron and inevitable impurities, wherein
an area ratio of carbides and carbonitrides that have a thickness of less than 0.4 μm is 0.20 area % or less, and
an area ratio M of carbides and carbonitrides that have a thickness of 0.4 μm or more in terms of percentage satisfies a relationship represented by the formula (1) below:
F=M−20×[C]>0 (1)
where [C] means a C content in the steel in percentage by mass.

8. The soft magnetic steel according to claim 7, having a composition of a ferrite single phase, and having a ferrite crystal grain size number in a range of 2.0 to 7.0.

9. The soft magnetic steel according to claim 7, further comprising, in percent by mass:
at least one kind of element selected from the group consisting of:
Si: 0.001 to 4.0%,
Cr: 0.01 to 4.0%,
B: 0.0003 to 0.01%,
Ti: 0.001 to 0.05%, and
Pb: 0.01 to 1.0%.

10. The soft magnetic steel according to claim 9, comprising:
Nb: 0.001 to 0.02%, together with Ti.

11. A method for manufacturing a soft magnetic steel, comprising:
heating a steel having compositions according to claim 7 to 950 to 1,200° C.;
hot-rolling the steel at a finish rolling temperature of 850° C. or higher;
quenching the rolled steel to 700 to 500° C. at an average cooling rate of 4 to 10° C./sec for 10 to 100 seconds; and
subsequently performing a carbide precipitation process in a temperature range of 700 to 500° C. for 100 seconds or more, the carbide precipitation process including decreasing the average cooling rate to less than 1.0° C./sec or keeping the temperature of the steel constant.

12. A method for manufacturing a soft magnetic steel, comprising:
heating a steel having compositions according to claim 9 to 950 to 1,200° C.;
hot-rolling the steel at a finish rolling temperature of 850° C. or higher;
quenching the rolled steel to 700 to 500° C. at an average cooling rate of 4 to 10° C./sec for 10 to 100 seconds; and
subsequently performing a carbide precipitation process in a temperature range of 700 to 500° C. for 100 seconds or more, the carbide precipitation process including decreasing the average cooling rate to less than 1.0° C./sec or keeping the temperature of the steel constant.

13. A method for manufacturing a soft magnetic steel, comprising:
heating a steel having compositions according to claim 9 to 950 to 1,200° C.;
hot-rolling the steel at a finish rolling temperature of 850° C. or higher;
quenching the rolled steel to 700 to 500° C. at an average cooling rate of 4 to 10° C./sec for 10 to 100 seconds; and
subsequently performing a carbide precipitation process in a temperature range of 700 to 500° C. for 100 seconds or more, the carbide precipitation process including decreasing the average cooling rate to less than 1.0° C./sec or keeping the temperature of the steel constant.

14. A method for manufacturing a soft magnetic steel, comprising:
heating a steel having compositions according to claim 10 to 950 to 1,200° C.;
hot-rolling the steel at a finish rolling temperature of 850° C. or higher;
quenching the rolled steel to 700 to 500° C. at an average cooling rate of 4 to 10° C./sec for 10 to 100 seconds; and
subsequently performing a carbide precipitation process in a temperature range of 700 to 500° C. for 100 seconds or more, the carbide precipitation process including decreasing the average cooling rate to less than 1.0° C./sec or keeping the temperature of the steel constant.

15. A soft magnetic component obtained by cold-working the soft magnetic steels according to claim 7.

16. A soft magnetic component obtained by cold-working the soft magnetic steels according to claim 8.

17. A soft magnetic component obtained by cold-working the soft magnetic steels according to claim 9.

18. A soft magnetic component obtained by cold-working the soft magnetic steels according to claim 10.
